(19) United States
(12) Patent Application Publication
(10) Pub. No.: US 2026/0015896 A1
(43) Pub. Date: Jan. 15, 2026

(54) KNOB ASSEMBLY

(71) Applicant: HYUNDAI MOBIS CO., LTD., Seoul (KR)

(72) Inventor: Jin Baek SEOK, Yongin-si (KR)

(73) Assignee: HYUNDAI MOBIS CO., LTD., Seoul (KR)

(21) Appl. No.: 19/171,628

(22) Filed: Apr. 7, 2025

(30) Foreign Application Priority Data
Jul. 10, 2024 (KR) 10-2024-0091117

(51) Int. Cl. E05B 85/10; B60R 7/06; E05B 83/30

(52) U.S. Cl. CPC E05B 85/10; E05B 83/30; B60R 7/06

(57) ABSTRACT

A knob assembly according to one embodiment of the present invention may include an opening and closing knob which opens or closes a glove box and in which a keyhole, into which a key is inserted, is formed in one surface of the opening and closing knob, a knob cover which slides forward or rearward to cover the one surface of the opening and closing knob, and a stopper which is formed on the one surface of the opening and closing knob to restrict movement of the knob cover when the knob cover moves rearward maximally, and the knob cover may move forward maximally to cover the keyhole.

### CROSS-REFERENCE TO RELATED APPLICATION

This application claims priority to and the benefit of Korean Patent Application No. 10-2024-0091117, filed on Jul. 10, 2024, the disclosure of which is incorporated herein by reference in its entirety.

### BACKGROUND

### 1. Field of the Invention

The present invention relates to a knob assembly, and more specifically, to a knob assembly which covers a portion on which a key set, into which a key is inserted, is disposed to improve design satisfaction and secures mechanical durability and operability.

### 2. Discussion of Related Art

A crash pad disposed in the front portion of a vehicle is disposed in front of a driver's seat and a passenger's seat. A glove box is disposed near the passenger's seat and provides a space for accommodating items of the passenger.

The glove box is disposed on an inner side of the crash pad and provided to be opened or closed using a knob. Although the glove box can be opened or closed using only the knob without a separate security device, the glove box can be provided with a key set for security of the accommodated items. The key set may be formed at a knob, and the glove box may be opened or closed by turning the key inserted into the knob.

However, in the case of a knob in which a key set is formed, since the key set can be visible to the passenger, there is a problem of luxuriousness degradation. In order to implement a luxurious design in a vehicle, a knob assembly, which covers a key set and of which the durability and operational quality are improved, is required.

### SUMMARY OF THE INVENTION

The present invention is directed to providing a knob assembly provided with a key set formed to secure the security of a glove box and a cover for covering the key set formed in a knob.

Objectives to be solved by the present invention are not limited to the above-described objectives, and other objectives which are not described above may be clearly understood by those skilled in the art through the following description.

According to an aspect of the present invention, there is provided a knob assembly including an opening and closing knob which opens or closes a glove box and in which a keyhole, into which a key is inserted, is formed in one surface of the opening and closing knob, a knob cover which slides forward or rearward to cover the one surface of the opening and closing knob, and a stopper which is formed on the one surface of the opening and closing knob to restrict movement of the knob cover when the knob cover moves rearward maximally.

The knob cover may move forward maximally to cover the keyhole.

Guide portions may be formed on both end portions of the opening and closing knob, sliding portions corresponding to shapes of the guide portions may be formed on both end portions of the knob cover, and the knob cover may move in a method in which the sliding portions come into contact with the guide portions and then slide.

At least a portion of each of the sliding portions formed in both end portions of the knob cover may be bent inward to form a recessed groove, and the guide portion of the opening and closing knob may be seated in the recessed groove so that the guide portion is in contact with the sliding portion.

The stopper may protrude from each of both end portions of the opening and closing knob, at least a portion of a front portion of the knob cover may be formed to be bent downward, and the stopper may come into contact with a bent portion to restrict movement when the sliding portion moves rearward.

A first catch portion may protrude between the stoppers of the opening and closing knob, a second catch portion may protrude from the knob cover, and one surface of the second catch portion may come into contact with the first catch portion to restrict the movement of the knob cover.

At least a portion of a rear portion of each of the knob cover and the opening and closing knob may protrude to be formed thick.

The opening and closing knob may be divided into a first region formed at a front side and a second region formed behind the first region and covered by the knob cover, the first region and the second region may be disposed with a step, the keyhole may be formed in the second region, and the step between the first region and the second region may correspond to a thickness of the knob cover so that the knob cover and the first region are coplanar with each other.

A fixing groove may be formed in the knob cover, and an upper side of the stopper may be fixedly inserted into the fixing groove when the knob cover moves forward and completely covers the second region.

The stopper may be formed of an elastic material.

A pin may protrude from a lower end of the guide portion, a groove may be formed in a lower end portion of the recessed groove, and the pin may be inserted into the groove when the knob cover completely covers or opens the opening and closing knob.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a glove box to which a knob assembly is applied according to one embodiment of the present invention;

FIG. 2 is a front view illustrating a knob cover of the knob assembly that covers an opening and closing knob according to one embodiment of the present invention;

FIG. 3 is a front view illustrating the knob cover of the knob assembly that opens the opening and closing knob according to one embodiment of the present invention;

FIG. 4 is a view illustrating an opening and closing knob according to another embodiment of the present invention;

FIG. 5 is a view illustrating a knob cover according to another embodiment of the present invention;

FIG. 6 is a side cross-sectional view illustrating an arrangement of the knob cover that covers the opening and closing knob according to one embodiment of the present invention;

FIG. 7 is a side cross-sectional view illustrating an arrangement of the knob cover that opens the opening and closing knob according to one embodiment of the present invention;

FIG. 8 is a front cross-sectional view illustrating the opening and closing knob according to one embodiment of the present invention;

FIG. 9 is a front cross-sectional view illustrating the knob cover according to one embodiment of the present invention;

FIG. 10 is a cross-sectional view illustrating the opening and closing knob and the knob cover that are assembled according to one embodiment of the present invention; and

FIG. 11 is a view illustrating an opening and closing knob and a stopper according to another embodiment of the present invention.

### DETAILED DESCRIPTION OF EXEMPLARY EMBODIMENTS

Since the present invention may be variously modified and have several embodiments, specific embodiments will be illustrated in the accompanying drawings and described in detail. However, this is not intended to limit the present invention to the specific embodiments, and it should be appreciated that all changes, equivalents, and substitutes falling within the spirit and technical scope of the present invention are encompassed in the present invention. In the description of the embodiments, certain detailed descriptions of the related art will be omitted when it is deemed that they may unnecessarily obscure the gist of the inventive concept.

Terms such as “first” and “second” may be used to describe various components, but the components are not limited by the above terms. These terms are used only to distinguish one component from another.

Terms used herein are only for the purpose of describing particular embodiments and are not intended to limit the present invention. Singular forms are intended to include the plural forms, unless the context clearly indicates otherwise. In the present specification, it should be understood that the terms “comprise,” “comprising,” “include,” and/or “including” used herein specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected, but this may also mean that two or more components are indirectly connected through other components or are physically connected and also electrically connected, or are one component even when referred to by different names according to positions or functions thereof.

In addition, when a first component is described as being formed or disposed “on” or “under” a second component, such a description includes both a case in which the two components are formed or disposed in direct contact with each other and a case in which one or more other components are interposed between the two components. In addition, when the first component is described as being formed “on or under” the second component, such a description may include a case in which the first component is formed at an upper side or a lower side with respect to the second component.

Hereinafter, embodiments of a knob assembly according to the present invention will be described in detail with reference to the accompanying drawings, and in the description with reference to the accompanying drawings, components which are the same or correspond to each other will be denoted by the same reference numerals, and redundant description thereof will be omitted.

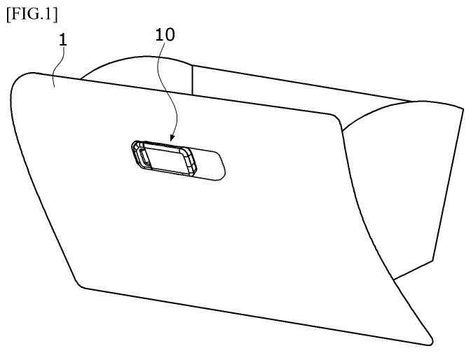

FIG. 1 is a view illustrating a glove box to which a knob assembly is applied according to one embodiment of the present invention.

Referring to FIG. 1, a knob assembly 10 according to one embodiment of the present invention may be disposed on one surface of the glove box 1. A user may operate an opening and closing knob 12 when opening or closing the glove box 1. The opening and closing knob 12 may be provided as a structure which may fix the glove box 1 while the glove box 1 is closed.

A passenger may open the glove box 1 by holding and pulling the opening and closing knob 12 to unlock a locking device. The glove box 1 may slide or rotate to be opened. Although it is illustrated in FIG. 1 of the present invention that the glove box 1 is a slide type glove box 1, but this is merely one embodiment, and the knob assembly 10 according to one embodiment of the present invention may be applied to the slidable glove box.

A separate key set may be applied to the glove box. Since the glove box to which the key set is applied is opened using a key, the security of the glove box can be ensured. Accordingly, the glove box to which the key set is applied may be manufactured according to the demand of the user.

The glove box 1 to which the conventional key set is applied has a design in which a keyhole formed in the key set is exposed at the outside. Accordingly, there is a problem that the key set is visible to the user and degrades design satisfaction. In the case of a recently launched vehicle, since a luxurious design is expected, it is necessary to prevent the exposure of a component such as a keyhole 121.

The knob assembly 10 according to the present invention may include the opening and closing knob 12 in which the keyhole 121 is formed and a knob cover 14 which covers one surface of the opening and closing knob 12. The knob cover 14 may be movably assembled on the one surface of the opening and closing knob 12 to cover or expose the one surface of the opening and closing knob 12. In the knob assembly 10 illustrated in FIG. 1, it is illustrated that the knob cover 14 covers the one surface of the opening and closing knob 12. Since the keyhole 121 formed in the opening and closing knob 12 is not visible to the user, luxuriousness can be secured.

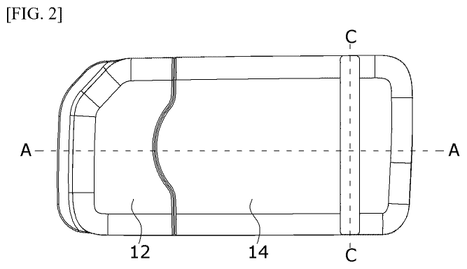

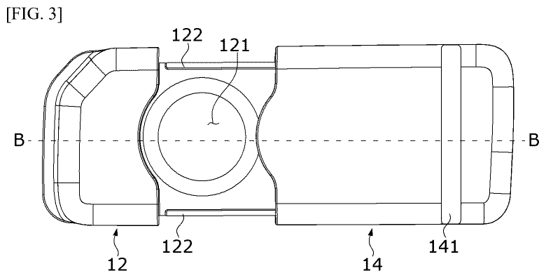

FIG. 2 is a front view illustrating the knob cover of the knob assembly that covers the opening and closing knob according to one embodiment of the present invention, and FIG. 3 is a front view illustrating the knob cover of the knob assembly that opens the opening and closing knob according to one embodiment of the present invention.

Referring to FIGS. 2 and 3, in the knob assembly 10 according to one embodiment of the present invention, the knob cover 14 may be slidably assembled on the one surface of the opening and closing knob 12 to cover the opening and closing knob 12. The keyhole 121 formed in the opening and closing knob 12 may be usually covered by the knob cover 14.

A protrusion 141 protruding in a width direction of the knob cover 14 may be formed on the knob cover 14. Since the protrusion 141 may protrude to correspond to one region of the knob cover 14, the protrusion 141 corresponds to a portion which may be held by the user when the user opens the knob cover 14. The user may hold the protrusion 141 and slide the knob cover 14 to open or close the knob cover 14.

As illustrated in FIG. 2, a portion of the opening and closing knob 12 which comes into contact with the knob cover 14 may be formed to correspond to a shape of the keyhole 121. As illustrated in FIG. 3, since the keyhole 121 is formed in a circular shape, a surface at which the knob cover 14 is in contact with the opening and closing knob 12 when the knob cover 14 covers the keyhole 121 may be formed in a curved line along a boundary of the keyhole 121.

Magnets (not shown) for fixing the knob cover 14 in a state in which the knob cover 14 covers the keyhole 121 may be formed in the knob cover 14 and the opening and closing knob 12. Each of the magnets may be disposed in one of the opening and closing knob 12 and the knob cover 14. When the knob cover 14 covers the keyhole 121, a front side of the knob cover 14 may come into contact with the opening and closing knob 12. When the magnets are disposed in portions in contact with each other, the knob cover 14 may be fixed to a corresponding position by a magnetic force. A strength of the magnetic force may be such that the user does not exert much force when opening the knob cover 14. That is, it is sufficient that the magnetic force acting between the magnets disposed in the knob cover 14 and the opening and closing knob 12 is such that the knob cover 14 is usually disposed and fixed to cover the keyhole 121.

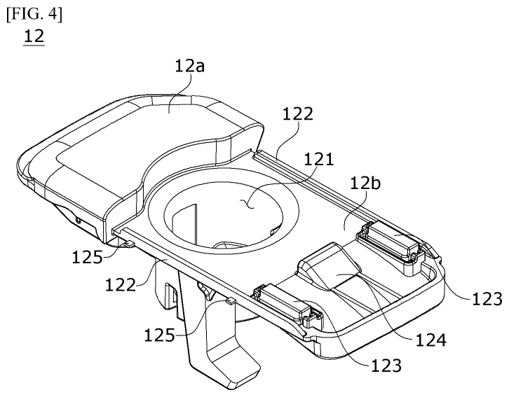

FIG. 4 is a view illustrating an opening and closing knob according to another embodiment of the present invention.

Referring to FIG. 4, an opening and closing knob 12 according to another embodiment of the present invention may include two regions 12a and 12b with a step. A front side of the opening and closing knob 12 may be formed as a first region 12a, and a rear side thereof may be formed as a second region 12b. The first region 12a may be formed to be stepped upward from the second region 12b. A keyhole 121 may be formed in the second region 12b, and a knob cover 14 may cover the second region 12b.

The opening and closing knob 12 may be formed as a structure to which the knob cover 14 is slidably assembled. Guide portions 122 may be formed on the opening and closing knob 12. The guide portions 122 may extend from both ends of the second region 12b toward the front and rear sides of the opening and closing knob 12. The guide portions 122 may be formed to protrude from both end portions. As will be described below, the guide portions 122 may be in contact with the knob cover 14 to guide the movement of the knob cover 14.

Stoppers 123 and a first catch portion 124 may be formed on the opening and closing knob 12 to restrict the movement of the knob cover 14. The stoppers 123 may be formed on both ends of the opening and closing knob 12. The stoppers 123 may be integrally formed with the opening and closing knob 12 or formed as separate parts.

The stoppers 123 may prevent the knob cover 14 from being separated from the opening and closing knob 12. The stoppers 123 may be formed to protrude from one surface of the opening and closing knob 12 to come into contact with the knob cover 14 and to restrict the movement of the knob cover 14 when the knob cover 14 is opened maximally. At least a portion of a front end portion of the knob cover 14 may be bent downward to come into contact with the stoppers 123.

In the case of the present embodiment, it is illustrated that the stoppers 123 are formed on a rear end portion of the second region 12b. A pair of stoppers 123 may be formed on both ends. Unlike this, one or three or more stoppers 123 may be disposed.

The first catch portion 124 of the opening and closing knob 12 according to another embodiment of the present invention may be disposed between the pair of stoppers 123. The first catch portion 124 may restrict the movement of the knob cover 14 by coming into contact with a second catch portion 142 formed on the knob cover 14 when the knob cover 14 is opened maximally.

The first catch portion 124 may primarily restrict the movement of the knob cover 14, and the stoppers 123 may secondarily prevent the separation of the knob cover 14. That is, the first catch portion 124 may come into contact with the knob cover 14 earlier than the stoppers 123, and when the first catch portion 124 is in contact with the knob cover 14, and an additional pressure or the like is applied to further move the knob cover 14, the stoppers 123 may come into contact with the knob cover 14 to prevent the separation of the knob cover 14.

Unlike this, both the first catch portion 124 and the stoppers 123 may restrict the movement of the knob cover 14. It can be seen that front boundary lines of the first catch portion 124 and the pair of stoppers 123 illustrated in FIG. 4 are collinearly disposed. According to the shape of the knob cover 14, the first catch portion 124 and the stoppers 123 may sequentially or simultaneously come into contact with the knob cover 14.

As will be described below, in the knob cover 14, the second catch portion 142 may be formed to come into contact with the first catch portion 124, and simultaneously comes into contact with the stoppers 123 illustrated in FIG. 4 to restrict the movement when the second catch portion 142 extends to both ends of the knob cover 14 in a width direction. When a portion of the second catch portion 142 extending to both ends is formed to be bent forward, even in a case in which a central portion of the second catch portion 142 comes into contact with the first catch portion 124, a state in which both ends of the second catch portion 142 are spaced a predetermined distance from the stoppers 123 may be maintained.

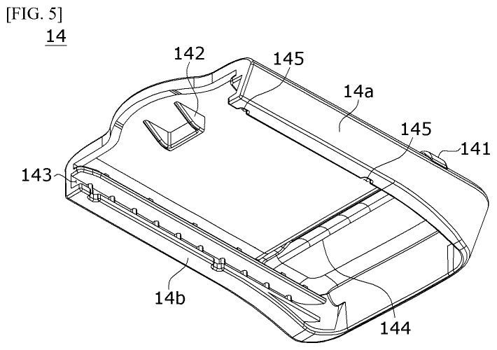

FIG. 5 is a view illustrating the knob cover according to another embodiment of the present invention.

Referring to FIG. 5, in the knob cover 14, both end portions 14a and 14b may be formed to be bent, and at least portions of the bent portions 14a and 14b may be recessed to form recessed grooves 143. The knob cover 14 and the opening and closing knob 12 may be assembled by seating both side surfaces of the opening and closing knob 12 in the recessed grooves 143. Specifically, the guide portions 122 formed on both end portions of the opening and closing knob 12 may be seated in the recessed grooves 143.

As described above, a protrusion 141 may be formed on the knob cover 14. The protrusion 141 may be formed in the width direction of the knob cover 14. A fixing groove 144 of which at least a portion is recessed may be formed in a surface opposite to the protrusion 141. The fixing groove 144 may be formed to be recessed in the knob cover 14. The fixing groove 144 may be long and formed to extend in the width direction of the knob cover 14 like the protrusion 141. Upper ends of the stoppers 123 or the first catch portion 124 may be seated in the fixing groove 144. That is, when the knob cover 14 completely covers the opening and closing knob 12, the upper ends of the stoppers 123 or the first catch portion 124 may be inserted into the fixing groove 144 such that the knob cover 14 is fixed at a corresponding position. Accordingly, an upper surface of the first catch portion 124 or the stoppers 123 may be formed such that a portion thereof protrudes. The shape of the protrusion may correspond to the shape of the fixing groove 144.

In a knob assembly 10 according to another embodiment of the present invention, pins 125 and grooves 145 may be formed such that the knob cover 14 may be maintained at a fixed position. Referring to FIG. 4, The pins 125 may be formed to protrude from side surfaces of the guide portions 122. Referring to FIG. 5, it can be seen that the grooves 145 are formed at lower ends of the recessed grooves 143. The pins 125 and the grooves 145 may be formed at locations corresponding to each other. The pins 125 may be formed at front sides and rear sides of the guide portions 122, and the grooves 145 may also be formed at front sides and rear sides of the recessed grooves 143.

When the knob cover 14 completely covers the opening and closing knob 12, the pins 125 may fix a position of the knob cover 14 by inserting the pins 125 into the grooves 145 at the corresponding locations. When the knob cover 14 opens the opening and closing knob 12, the pins 125 formed at the rear sides of the guide portions 122 are inserted into the grooves 145 formed at a front side of the knob cover 14 so that a position of the knob cover 14 may be fixed. In FIG. 4, although it is illustrated that each of the pins 125 protrudes in a quadrangular shape, the pin 125 may include a curved surface for preventing damage and preventing large resistance hindering the movement of the knob cover 14.

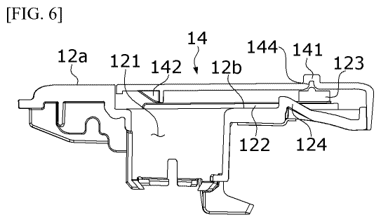

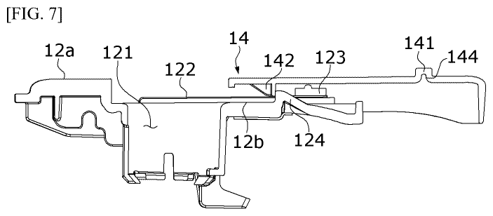

FIG. 6 is a side cross-sectional view illustrating an arrangement of the knob cover that covers the opening and closing knob according to one embodiment of the present invention, and FIG. 7 is a side cross-sectional view illustrating an arrangement of the knob cover that opens the opening and closing knob according to one embodiment of the present invention.

FIGS. 6 and 7 are views illustrating cross-sections along line A-A and like B-B of FIGS. 2 and 3, respectively.

Referring to FIG. 6, it can be seen that the knob cover 14 covers the opening and closing knob 12. The opening and closing knob 12 may include a first region 12a and a second region 12b formed with a step as described above. The first region 12a may be disposed to be coplanar with an upper surface of the knob cover 14 to implement a luxurious design. Accordingly, the step between the first region 12a and the second region 12b may correspond to a thickness of the knob cover 14.

When the knob cover 14 covers the second region 12b of the opening and closing knob 12, an upper side of the stopper 123 may be fixedly seated in the fixing groove 144. In order to implement this, the upper side of the stopper 123 may be formed such that a portion thereof protrudes.

Referring to FIG. 7, it can be seen that the knob cover 14 opens the opening and closing knob 12. The knob cover 14 slidably moves to expose the keyhole 121 of the opening and closing knob 12. When the knob cover 14 moves maximally, the second catch portion 142 formed on the knob cover 14 may come into contact with the first catch portion 124 protruding from the opening and closing knob 12 to restrict the movement of the knob cover 14. It is illustrated in FIGS. 6 and 7 that the stopper 123 is disposed at a position spaced a predetermined distance from the first catch portion 124 in a rearward direction.

As an upper surface of the stopper 123 is formed to protrude for an upper portion of the stopper 123 to be inserted into the fixing groove 144, the knob cover 14 and the upper surface of the stopper 123 may be in contact with each other. That is, when the knob cover 14 slides, a state in which the upper surface of the stopper 123 is in contact with the knob cover 14 may be maintained. Accordingly, when the stopper 123 may be formed of an elastic material. In this case, when the knob cover 14 slides, at least a portion of the stopper 123 may be bent to reduce interference with the movement of the knob cover 14. It is illustrated that the height of the stopper 123 illustrated in FIG. 7 is smaller than that illustrated in FIG. 6 to help understanding. That is, as the stopper 123 is formed of the elastic material, the stopper 123 may maintain a state of being in contact with the knob cover 14, and at least a portion thereof may be bent according to the movement of a portion of the knob cover 14.

At least of a portion of a front end portion of the knob cover 14 may be formed to be bent downward. The bent portion may come into contact with the stoppers 123 when the knob cover 14 is opened maximally or more. The stoppers 123 may come into contact with the bent front end portion of the knob cover 14 to restrict the movement of the knob cover 14.

In cross-sections illustrated in FIGS. 6 and 7, the opening and closing knob 12 and the knob cover 14 may become thicker toward the rear thereof. That is, a rear side may have a shape protruding downward from a front side. The reason why the rear side is formed to be thicker than the front side is that the rear side serves as a handle when the glove box 1 is opened or closed. When the user holds and pulls the opening and closing knob 12, the user holds and pulls the rear side of the knob assembly 10. Accordingly, a corresponding portion may be formed to have a great thickness such that a finger of the user can easily hook in and pull the corresponding portion.

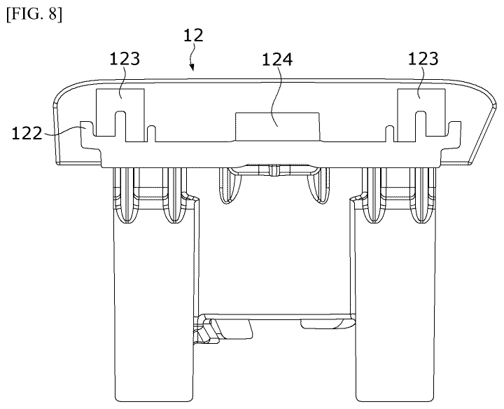

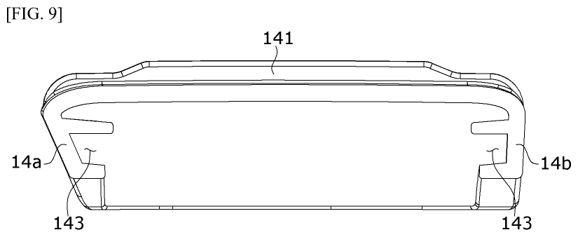

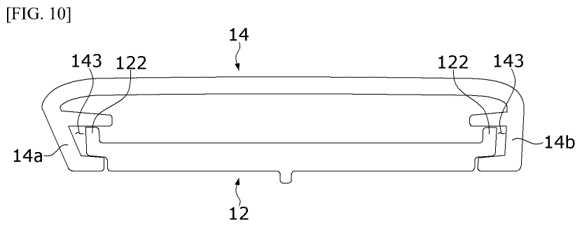

FIG. 8 is a front cross-sectional view illustrating the opening and closing knob according to one embodiment of the present invention, FIG. 9 is a front cross-sectional view illustrating the knob cover according to one embodiment of the present invention, and FIG. 10 is a cross-sectional view illustrating the opening and closing knob and the knob cover that are assembled according to one embodiment of the present invention.

FIGS. 8 and 9 are views illustrating cross sections along line C-C of FIG. 2.

Referring to FIG. 8, the guide portions 122 may be formed on both ends of the opening and closing knob 12 according to one embodiment of the present invention. Each of the guide portions 122 may be formed such that a portion thereof protrudes and may extend toward the front and rear sides of the opening and closing knob 12. The guide portion 122 may guide movement of the knob cover 14 while in contact with the knob cover 14. The guide portion 122 serves as a type of a rail.

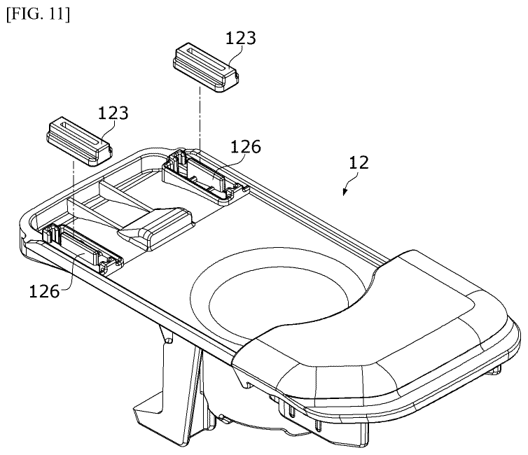

Each of the stoppers 123 may be disposed at a position adjacent to the guide portion 122. The stopper 123 may be integrally formed with the opening and closing knob 12, and unlike this, the stopper 123 may be formed as a separate part and assembled thereto. It is illustrated that the stopper 123 illustrated in FIG. 8 is manufactured as a separate part and then fitted into an assembly part 126 protruding from the portion adjacent to the guide portion 122. This corresponds to that illustrated in FIG. 11.

Referring to FIG. 9, at least portions of both end portions 14a and 14b of the knob cover 14 according to one embodiment of the present invention may be bent downward. At least the portions of the bent portions 14a and 14b may be recessed inward to form the recessed grooves 143. The guide portions 122 may be seated in the recessed grooves 143 as in FIG. 10.

The knob cover 14 may move along the guide portion 122 in a front-rear direction. Since a space between the recessed grooves 143 disposed in both end portions of the knob cover 14 corresponds to a width of the opening and closing knob 12, the knob cover 14 may be assembled by sliding from the rear side toward the front side of the opening and closing knob 12.

FIG. 10 is a view illustrating the opening and closing knob 12 and the knob cover 14 that are assembled. Both end portions of the opening and closing knob 12 are seated in the recessed grooves 143 of the knob cover 14. Particularly, the guide portions 122 formed at both sides of the opening and closing knob 12 may be in contact with inner surfaces of the recessed grooves 143. The knob cover 14 may slide along outer surfaces of the guide portions 122 while in contact with the recessed grooves 143.

FIG. 11 is a view illustrating an opening and closing knob and a stopper according to another embodiment of the present invention.

Each of stoppers 123 according to still another embodiment of the present invention may be formed as a part separated from an opening and closing knob 12. The stopper 123 may be manufactured as the separate part and assembled to an assembly part 126 formed on the opening and closing knob 12.

In the case of the present embodiment, it is illustrated that the stopper 123 is assembled by being fitted into an upper end portion of the opening and closing knob 12. When the stopper 123 is manufactured as the separate part, the stopper 123 may be formed of a material different from that of the opening and closing knob 12. Accordingly, the stopper 123 may be formed of a material selected from materials which are not hard materials such as a plastic resin. As an example, the stopper 123 may be formed of an elastic material (rubber or the like) capable of absorbing an impact.

According to embodiments of the present invention, a knob cover slidably assembled to an opening and closing knob can slide to expose or cover a keyhole, thereby securing security and implementing a luxurious design.

Various useful advantages and effects of the present invention are not limited to the above-described contents, and can be more easily understood in the detailed description of specific embodiments of the present invention.

While the present invention has been described above with reference to specific embodiments of the present invention, it may be understood by those skilled in the art that various modifications and changes of the present invention may be made within a range not departing from the spirit and scope of the present invention defined by the appended claims.

What is claimed is:

1. A knob assembly comprising:
an opening and closing knob which opens or closes a glove box and in which a keyhole, into which a key is inserted, is formed in one surface of the opening and closing knob;
a knob cover which slides forward or rearward to cover the one surface of the opening and closing knob; and
a stopper which is formed on the one surface of the opening and closing knob to restrict movement of the knob cover when the knob cover moves fully rearward,
wherein the knob cover moves fully forward to cover the keyhole.

2. The knob assembly of claim 1, wherein:
guide portions are formed on both end portions of the opening and closing knob;
sliding portions having shapes corresponding to the guide portions are formed on both end portions of the knob cover; and
the knob cover is configured to move so the sliding portions come into contact with the guide portions and then slide.

3. The knob assembly of claim 2, wherein:
at least a portion of each of the sliding portions formed on both end portions of the knob cover is bent inward to form a recessed groove; and
each guide portion of the opening and closing knob is received in the recessed groove, and the guide portion is in contact with the corresponding sliding portion.

4. The knob assembly of claim 3, wherein:
the stopper protrudes from each of both end portions of the opening and closing knob;
at least a portion of a front portion of the knob cover is configured to bend downward; and
the stopper comes into contact with a bent portion to restrict movement when the sliding portion moves rearward.

5. The knob assembly of claim 4, wherein:
a first catch portion protrudes between the stoppers of the opening and closing knob;
a second catch portion protrudes from the knob cover; and
one surface of the second catch portion comes into contact with the first catch portion to restrict movement of the knob cover.

6. The knob assembly of claim 5, wherein at least a portion of a rear portion of each of the knob cover and the opening and closing knob is formed with increased thickness.

7. The knob assembly of claim 6, wherein:
the opening and closing knob is divided into a first region formed at a front side and a second region located behind the first region and covered by the knob cover;
the first region and the second region are arranged with a step;
the keyhole is formed in the second region; and
the step between the first region and the second region corresponds to a thickness of the knob cover so that the knob cover and the first region are coplanar with each other.

8. The knob assembly of claim 7, wherein:
a fixing groove is formed in the knob cover; and
an upper side of the stopper is fixedly inserted into the fixing groove when the knob cover moves forward and completely covers the second region.

9. The knob assembly of claim 8, wherein the stopper is formed of an elastic material.

10. The knob assembly of claim 8, wherein:
a pin protrudes from a lower end of the guide portion;
a groove is formed in a lower end portion of the recessed groove; and
the pin is configure to be inserted into the groove when the knob cover is positioned to completely cover or to completely open the opening and closing knob.
